(19) United States
(12) Patent Application Publication
(10) Pub. No.: US 2016/0357633 A1
(43) Pub. Date: Dec. 8, 2016

(54) Systems and Methods for Multi-Storage Medium Data Storage and Recovery

(71) Applicant: Avago Technologies General IP (Singapore) Pte. Ltd., Singapore (SG)

(72) Inventors: Bruce A. Wilson, San Jose, CA (US); Shaohua Yang, San Jose, CA (US)

(21) Appl. No.: 14/731,734

(22) Filed: Jun. 5, 2015

(51) Int. Cl. G06F 11/10; G06F 3/06

(52) U.S. Cl. CPC G06F 11/1076; G06F 3/0619; G06F 3/064; G06F 3/0683

(57) ABSTRACT

The present invention is related to systems and methods for storing and recovering data from a distributed storage system.

### BACKGROUND OF THE INVENTION

The present inventions are related to systems and methods for storing and recovering data from a distributed storage system.

Modern enterprise storage systems offer good reliability and availability. This is made possible through the use of multiple layers of redundant hardware and advanced error correction coding. Typically error correction is applied in layers with increasing abstraction and greater overhead at higher levels of the system. Within a hard disk drive, error correction operates on the level of individual recorded bits. Using reliability values for each bit computed from the analog read-back signal a low density parity check decoder is able to recover errors using, for example, ten (10) to twelve (12) percent overhead for redundant parity information. At higher levels of the enterprise storage system error correction operates at the level of logical blocks that are not available at the hard disk drive level that can be reconstructed using RAIDS or RAID6 codes that require, for example, fifteen (15) to thirty (30) percent overhead for redundant parity information. At the file system level reliability and availability are often addressed by duplicating files where a single file may be stored in two or three geographically dispersed data centers effectively adding between one hundred (100) and two hundred (200) percent overhead. Such an approach, while effective is costly in terms of the overhead used to assure the ability to recover data.

Hence, for at least the aforementioned reasons, there exists a need in the art for advanced systems and methods for storing and/or accessing data from a storage system.

### BRIEF SUMMARY OF THE INVENTION

The present inventions are related to systems and methods for storing and recovering data from a distributed storage system.

Some embodiments of the present invention provide storage systems that include: a first storage device, a second storage device, and a storage system controller. The first storage device includes a first storage medium and a first data detector circuit. The first data detector circuit is operable to apply a data detection algorithm to a first pre-correction data set derived from the first storage medium to yield a first detected output. The second storage device includes a second storage medium and a second data detector circuit. The second data detector circuit is operable to apply the data detection algorithm to a second pre-correction data set derived from the second storage medium to yield a first detected output. The storage system controller includes a data decoder circuit and a codeword assembly circuit. The storage system controller is operable to: receive the first detected output and the second detected output; aggregate the first detected output and the second detected output by the codeword assembly circuit to yield a unified detected output; and apply a data decode algorithm to the unified detected output by the data decoder circuit to yield a decoded output.

This summary provides only a general outline of some embodiments of the invention. The phrases “in one embodiment,” “according to one embodiment,” in various embodiments“, in one or more embodiments”, “in particular embodiments” and the like generally mean the particular feature, structure, or characteristic following the phrase is included in at least one embodiment of the present invention, and may be included in more than one embodiment of the present invention. Importantly, such phases do not necessarily refer to the same embodiment. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a data storage system including multiple individual storage devices by a multi-disk distribution and processing controller in accordance with one or more embodiments of the present invention;

FIG. 2 depicts a detailed block diagram of a data storage system including multiple individual storage devices controlled by a multi-disk distribution and processing controller in accordance with one or more embodiments of the present invention;

FIG. 3 is a flow diagram showing a method in accordance with some embodiments of the present invention for encoding and storing data across multiple storage media;

FIG. 4 graphically depicts the data encoding and storing processes discussed in relation to FIG. 3; and

FIGS. 5-6 are flow diagrams showing methods in accordance with some embodiments of the present invention for recovering data stored across multiple storage media.

### DETAILED DESCRIPTION OF THE INVENTION

The present inventions are related to systems and methods for storing and recovering data from a distributed storage system.

Various embodiments are directed to systems, circuits and/or methods for employing bit-level reliability information at a level above individual storage devices. An individual storage device may be, but is not limited to, a hard disk drive. In this way a single layer of error correction can protect against both routine errors arising during the recording process which was traditionally handled directly on the individual storage devices, but can also protect against catastrophic failure of any one or more of the individual storage devices controlled by the level above the individual storage devices. In such embodiments, the data transferred between the individual storage devices and the level above is modified from existing SAS, SATA or NVME interfaces that transfer properly decoded data blocks checked by parity to ensure integrity from the individual storage devices. Rather, data transfers between the individual storage devices and the next level includes either raw detected or equalized data sets, allowing the upper level to perform data decoding algorithms and/or data detection algorithms.

In some particular embodiments individual blocks (for example, sectors) are encoded to yield an encoded codeword. This encoded codeword is then partitioned into a number of segments with each segment recorded on a different individual storage device. In the event of an unrecoverable failure of an individual storage device, a segment of data from a block may be completely missing. The bits corresponding to the missing segment(s) are treated as erasures by a low density parity check decoder circuit included in a controller circuit controlling multiple individual storage devices, and the bits can still be recovered very effectively provided that the number of segments is sufficiently large and each segment correspondingly is a small part of the total block. In some cases, the erasure enabled low density parity check decoding may be similar to that performed on traditional individual storage devices, but implemented across multiple individual storage devices. Such an approach offers an advantage of effective protection against catastrophic failure of an individual storage device without additional parity overhead. In fact, in some cases, the parity overhead previously incurred at the combination of the individual storage device level and the next level up can be reduced and yet provide improved performance compared with prior storage approaches.

In yet another embodiment, a RAID-like product code is used with one set of parity applied to data in a single block on a single individual storage device and another set of parity checks, each applied to a small portion of each block. One or more additional blocks may be dedicated for redundant parity checks that span across the individual storage devices as is done today in RAID systems. By changing the interface between the individual storage devices and RAID subsystem there is an alternative to simply growing the size of the recorded blocks to accommodate these additional parity bits. A RAID-like product code can recover missing data due to the catastrophic failure of an individual storage device or other component, as is done today. When bit reliability information is used this type of RAID code can correct a large number of blocks in which the parity dedicated for that block is not sufficient to correct errors introduced by imperfections in the recording process. In a traditional RAID system these blocks would fail as “hard errors”. A traditional RAID system can recover missing data due to one or sometime more (RAID6) of these hard errors. Iterative soft decoding of the product code could potentially recover all data even when no individual block could be recovered independently. By using soft information to decode the product code at the system level we can improve latency since data recovery steps on the individual storage devices would very seldom be required to recover “soft errors” since these could be recovered from the product code. A further benefit of decoding the RAID-like product code iteratively is that even without soft information the errors present on typical blocks during read back can be recovered. This enables a low latency, low power read back in which hard decision data are read from the HDD with no error correction and with no reliability or other soft information. In cases where this is insufficient to recover the data the subsystem could query the individual storage devices for soft information on retry.

Some embodiments of the present invention provide storage systems that include: a first storage device, a second storage device, and a storage system controller. The first storage device includes a first storage medium and a first data detector circuit. The first data detector circuit is operable to apply a data detection algorithm to a first pre-correction data set derived from the first storage medium to yield a first detected output. The second storage device includes a second storage medium and a second data detector circuit. The second data detector circuit is operable to apply the data detection algorithm to a second pre-correction data set derived from the second storage medium to yield a first detected output. The storage system controller includes a data decoder circuit and a codeword assembly circuit. The storage system controller is operable to: receive the first detected output and the second detected output; aggregate the first detected output and the second detected output by the codeword assembly circuit to yield a unified detected output; and apply a data decode algorithm to the unified detected output by the data decoder circuit to yield a decoded output.

In some instances of the aforementioned embodiments, the storage system controller is implemented as part of a first integrated circuit, the first data detector circuit is implemented as part of a second integrated circuit, and the second data detector circuit is implemented as part of a third integrated circuit. In various instances of the aforementioned embodiments, the first storage device further includes a first write circuit and the second storage device further includes a second write circuit. The storage system controller further includes: a data encoder circuit operable to encode a user data input to yield an encoded codeword; a codeword segmenting circuit operable to divide the encoded codeword into multiple portions including at least a first portion and a second portion; and a data storage circuit operable to direct the first portion to the first write circuit and the second portion to the second write circuit. The first portion corresponds to the first pre-correction data set and the second portion corresponds to the second pre-correction data set. In one or more instances of the aforementioned embodiments, the first storage device is a first hard disk drive and the second storage device is a second storage device.

In some instances of the aforementioned embodiments, the decoded output is a first decoded output and the storage system controller further comprises a third data detector circuit. The storage system controller is further operable to: receive the first pre-correction data set and the second pre-correction data set; aggregate the first pre-correction data set and the second pre-correction data set by the codeword assembly circuit to yield a unified pre-correction output; apply a data detection algorithm to the unified pre-correction output by the third data detector circuit to yield a third detected output; and apply the data decode algorithm to the third detected output by the data decoder circuit to yield a second decoded output. In some cases, the first pre-correction data set includes more bits than the first detected output. In various cases, the third detected output includes soft decisions, and the first detected output and the first detected output each include only hard decision data. In one or more cases, the codeword assembly circuit is further operable to modify the third detected output to erase elements of the third detected output corresponding to the first pre-correction data set when the first storage device is identified as failed. In one or more instances of the aforementioned embodiments, access to the storage system is controlled by a requesting device communicably coupled to the storage system controller. In various instances of the aforementioned embodiments, the data decoder circuit is a low density parity check decoder circuit.

Other embodiments of the present invention provide storage systems that include: a first storage device, a second storage device, and a storage system controller. The first storage device includes a first storage medium and a first analog to digital converter circuit. The first analog to digital converter circuit is operable to convert a first analog signal derived from the first storage medium to yield a first series of samples. The second storage device includes a second storage medium and a second analog to digital converter circuit. The second analog to digital converter circuit is operable to convert a second analog signal derived from the second storage medium to yield a second series of samples. The storage system controller includes a data decoder circuit, a data detector circuit, and a codeword assembly circuit. The storage system controller is operable to: receive a first pre-correction output derived from the first series of samples and a second pre-correction output derived from the second series of samples; aggregate the first pre-correction data set and the second pre-correction data set by the codeword assembly circuit to yield a unified pre-correction output; apply a data detection algorithm to a detector input derived from the unified pre-correction output by the third data detector circuit to yield a third detected output; and apply the data decode algorithm to the third detected output by the data decoder circuit to yield a second decoded output.

In some instances of the aforementioned embodiments, the storage system controller is implemented as part of a first integrated circuit, the first analog to digital converter circuit is implemented as part of a second integrated circuit, and the second analog to digital converter circuit is implemented as part of a third integrated circuit. In various instances of the aforementioned embodiments, the first storage device further comprises a first equalizer circuit operable to equalize the first series of samples to yield a first equalized output, the second storage device further comprises a second equalizer circuit operable to equalize the second series of samples to yield a second equalized output, the first pre-correction output is the first equalized output and the second pre-correction output is the second equalized output, and the detector input is the unified pre-correction output. In other instances of the aforementioned embodiments, the first pre-correction output is the first series of samples and the second pre-correction output is the second series of samples, wherein the storage system controller further includes an equalizer circuit, and the equalizer circuit is operable to equalize the unified pre-correction output to yield the detector input. In one or more instances of the aforementioned embodiments, the codeword assembly circuit is further operable to modify the detected output to erase elements of the detected output corresponding to the first pre-correction data set when the first storage device is identified as failed.

Yet other embodiments provide methods for data storage that include: providing a first storage device including a first storage medium and a first data detector circuit; wherein the first data detector circuit is operable to apply a data detection algorithm to a first pre-correction data set derived from the first storage medium to yield a first detected output; providing a second storage device including a second storage medium and a second data detector circuit, wherein the second data detector circuit is operable to apply the data detection algorithm to a second pre-correction data set derived from the second storage medium to yield a first detected output; using a storage system controller to: encode a user data input to yield an encoded data set; segment the user data input to yield multiple portions including at least a first portion and a second portion; direct the first portion to the first storage device to be stored on the first storage medium, wherein the first portion corresponds to the first pre-correction data set; and direct the second portion to the second storage device to be stored on the second storage medium, wherein the second portion corresponds to the second pre-correction data set.

In some instances of the aforementioned embodiments, the methods further include: using the storage system controller to: receive a read request; request the first detected data set from the first storage device; request the second detected data set from the second storage device; receive the first detected output and the second detected output; aggregate the first detected data set and the second detected data set to yield a unified detected output; and apply the data decode algorithm to the unified detected output to yield a decoded output. In other instances of the aforementioned embodiments, the methods further include: using the storage system controller to: receive a read request; request the first pre-correction data set from the first storage device; request the second pre-correction data set from the second storage device; receive the first pre-correction output and the second pre-correction output; aggregate the first pre-correction data set and the second pre-correction data set to yield a unified pre-correction output; apply a data detection algorithm to a detector input derived from the unified pre-correction output by a third data detector circuit to yield a third detected output; and apply the data decode algorithm to the third detected output by the data decoder circuit to yield a second decoded output. In some such cases, the methods further include erasing a portion of the third detected output corresponding to the first pre-correction output based upon a failure of the first storage device.

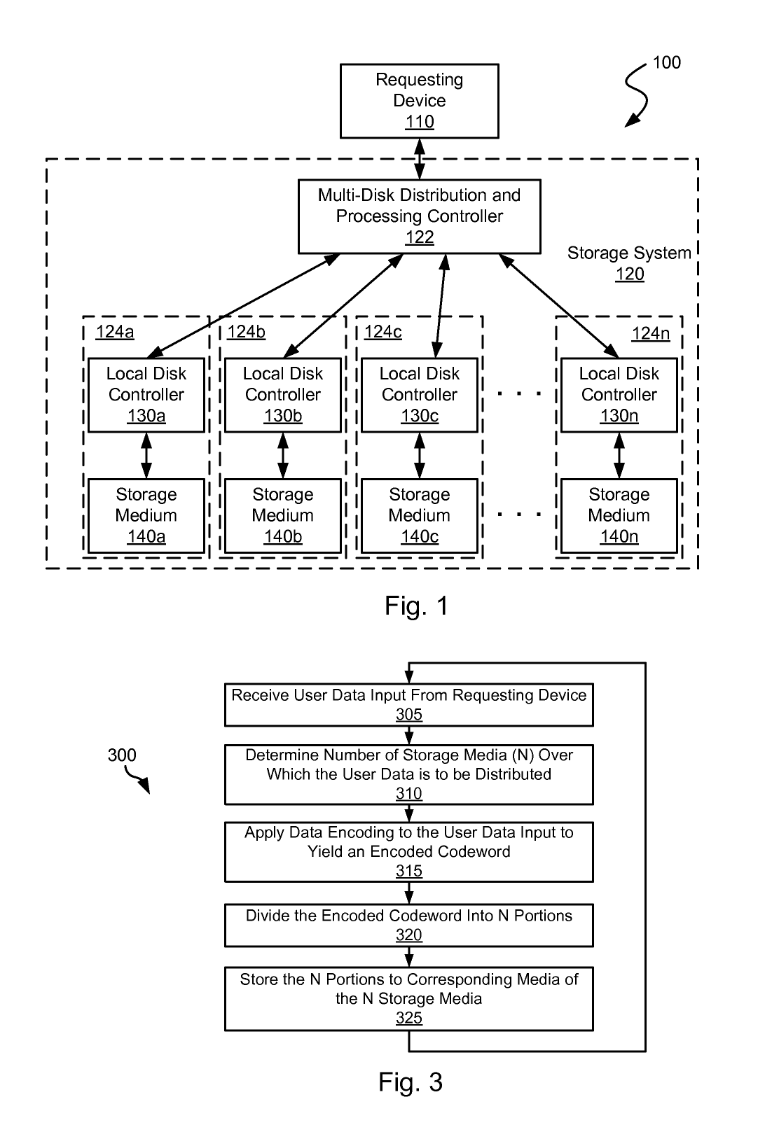

Turning to FIG. 1, a data access system 100 is shown with a requesting device 110 communicatively coupled to a storage system 120. Requesting device 110 may be any device capable of accessing storage with either read or write commands. As such, a requesting device may be, but is not limited to, a server or other computer. Storage system 100 includes multiple individual storage devices 124 controlled by a multi-disk distribution and processing controller 122 in accordance with one or more embodiments of the present invention. Each of storage devices 124 include a local disk controller 130 and a storage medium 140.

Multi-disk distribution and processing controller 122 includes a data encoder circuit to yield an encoded codeword. In addition, multi-disk distribution and processing controller 122 divides the encoded codeword into a number of segments where the number of segments corresponds to the number of individual storage devices 124 included in storage system 120. Multi-disk distribution and processing controller 122 then writes each of the segments to a respective one of individual storage devices.

When requested by requesting device 110, multi-disk distribution and processing controller 122 requests the component segments from the respective individual storage devices 124. In turn, local disk controller 130 of each of the individual storage devices 124 read the respective segments from the corresponding storage medium 140. Local disk controller 130 applies a data detection algorithm to the data retrieved from storage medium 140 to yield a detected output for the particular requested segment. The respective detected outputs are then provided by corresponding individual storage devices 124 to multi-disk distribution and processing controller 122.

Multi-disk distribution and processing controller 122 assembles the respective detected outputs into a unified detected output. Multi-disk distribution and processing controller 122 applies a data decoding algorithm to the unified detected output to yield a decoded output. Where the decoded output converges (i.e., all errors are corrected), the resulting data is provided to requesting device 110.

In some cases where additional processing capability is needed (where for example, the decoded output failed to converge), respective local disk controllers 130 provide pre-correction data to multi-disk distribution and processing controller 122. In some cases, the pre-correction data may be also pre-detected data. As used herein, “pre-correction data set” is any data set that has not yet been subjected to a processing algorithm that corrects one or more bits within the data set. Thus, as an example, local disk controller 130 may include an analog front end circuit that applies analog processing to an analog signal sensed from the corresponding storage medium 140 to yield an analog input, and an analog to digital converter circuit converts the analog input into a series of digital samples. As no correction has yet been applied, one or more of the digital samples would be considered a pre-correction data set. Continuing the example, an equalizer applies an equalization algorithm to the digital samples to yield an equalized input. As equalization equalizes data, but does not correct any bits of the data, the equalized input would also be considered a pre-correction data set. Continuing the example, a data detector circuit (e.g., a maximum a posteriori data detector circuit) applies a data detection algorithm to the equalized input to yield a detected output. The detected output includes bit decision data that has also not been corrected, and as such the detected output would also be considered a pre-correction data set. This bit decision data may be hard decision data, soft decision data, or a combination of hard decision data and soft decision data. The terms “hard decision” and “soft decision” are used in their broadest sense. In particular, “hard decisions” are outputs indicating an expected original input value (e.g., a binary ‘1’ or ‘0’), and the “soft decisions” indicate a likelihood that corresponding hard decisions are correct. In general, soft decisions are represented by more bits than the corresponding hard decisions. Based upon the disclosure provided herein, one of ordinary skill in the art will recognize a variety of hard decisions and soft decisions that may be used in relation to different embodiments of the present invention. A data decoding algorithm is often applied to the detected output to correct one or more bit errors within the detected output to yield a decoded output. As the decoded output includes one or more corrected bit errors it would not be properly considered a pre-correction data set. As used herein, “pre-detected data set” is any data set that has not yet been subjected to a processing algorithm that makes bit decisions. Thus, using the example above, as the analog output is a value corresponding to an input signal and has not yet been subject to a bit decision algorithm, one or more of the digital samples would be considered a pre-detected data set. For the same reason, the equalized input would also be considered a pre-detected data set. In contrast, neither the detected output nor the decoded output would be considered a pre-detected data set. As some examples, pre-correction data provided by local disk controllers may be digital samples (i.e., an x-output), an equalized output (i.e., a y-output), or a detected output depending upon the implementation.

In such a scenario, multi-disk distribution and processing controller 122 assembles the received pre-correction data into a unified pre-correction data output. Multi-disk distribution and processing controller 122 applies a combination of a data detection algorithm and a data decoding algorithm to recover the originally stored data. By applying the data detection algorithm in multi-disk distribution and processing controller 122, soft data from application of the data detection algorithm is available for use by the data decoding algorithm. Transferring detected data from each of individual storage devices 124 requires substantially less bandwidth than transferring pre-correction data. As such, it may be that the data detection algorithm is applied in a standard access scenario, but that when data recovery is not possible in such a scenario, pre-correction data may be transferred from the individual storage devices 124 to multi-disk distribution and processing controller 122.

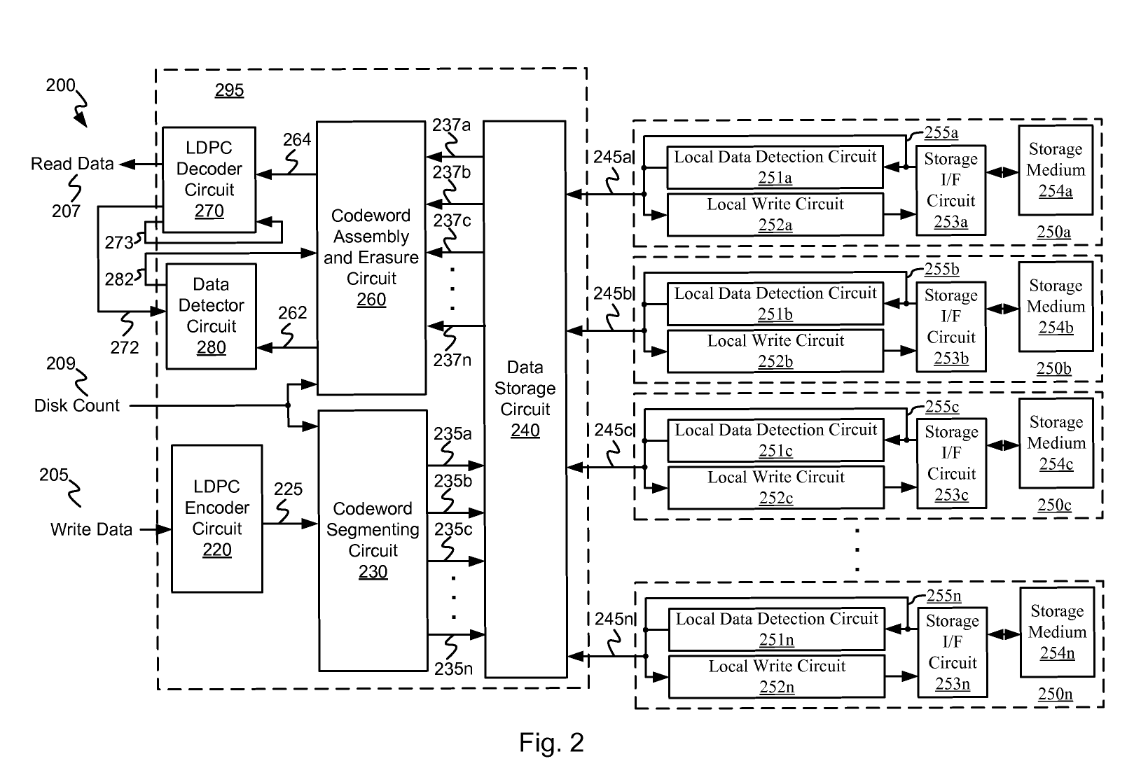

Turning to FIG. 2, a data storage system 200 is shown in accordance with one or more embodiments of the present invention. Data storage system 200 may be used in place of storage system 120 discussed above in relation to FIG. 1. Data storage system 200 includes multiple individual storage devices 250 controlled by a multi-disk distribution and processing controller 295 in accordance with one or more embodiments of the present invention. As shown, multi-disk distribution and processing controller 295 includes a data storage circuit 240, a codeword assembly and erasure circuit 260, a codeword segmenting circuit 230, a low density parity check decoder circuit 270, a data detector circuit 280, and a low density parity check encoder circuit 220. Each of individual storage devices 250 includes control circuitry and a storage medium 254. The control circuitry includes a storage interface circuit 253, a local data detection circuit 251, and a local write circuit 252.

In some cases, data detector circuit 280 may be, but is not limited to, a Viterbi algorithm detector circuit or a maximum a posteriori detector circuit as are known in the art. Of note, the general phrases “Viterbi data detection algorithm” or “Viterbi algorithm data detector circuit” are used in their broadest sense to mean any Viterbi detection algorithm or Viterbi algorithm detector circuit or variations thereof including, but not limited to, bi-direction Viterbi detection algorithm or bi-direction Viterbi algorithm detector circuit. Also, the general phrases “maximum a posteriori data detection algorithm” or “maximum a posteriori data detector circuit” are used in their broadest sense to mean any maximum a posteriori detection algorithm or detector circuit or variations thereof including, but not limited to, simplified maximum a posteriori data detection algorithm and a max-log maximum a posteriori data detection algorithm, or corresponding detector circuits. Based upon the disclosure provided herein, one of ordinary skill in the art will recognize a variety of data detector circuits that may be used in relation to different embodiments of the present invention. Local data detector circuit 280 provides a detected output that includes both hard decision data and soft decision data. In various cases, local data detection circuit 251 may be, but is not limited to, a Viterbi algorithm detector circuit or a maximum a posteriori detector circuit as are known in the art. Local data detection circuit 251 may provides a detected output that includes only hard decisions.

Each of individual storage devices 250 are communicatively coupled to multi-disk distribution and processing controller 295 via a bus system. Any bus system known in the art may be used to connect individual storage devices 250 to multi-disk distribution and processing controller 295. As just one example, the bus system may be a PCIe bus system as is known in the art. Based upon the disclosure provided herein, one of ordinary skill in the art will recognize a variety of bus systems that may be used in relation to different embodiments. In some cases, the bus system includes a number of dedicated busses 245 each connecting a respective one of individual storage devices 250 to multi-disk distribution and processing controller 295. In other cases, all of dedicated busses 245 are replaced by a single unified bus over which data is transferred between individual storage devices 250 and multi-disk distribution and processing controller 295.

In operation, a requesting device (not shown) provides user data (i.e., write data 205) to be stored to storage system 200. In addition, a number of individual storage devices 250 (N) included in storage system 200 is provided as a disk count 209. This number may be user programmable or fixed in a particular storage system. In some cases, this number is selected to correspond to the maximum number of errors that can be corrected using the selected overhead. Thus, for example, where an encoded codeword includes forty-thousand bits, and the selected amount of overhead allows for correction of up to seven thousand bits, N may be determined as the whole number resulting from the division of the total size of the encoded codeword divided by the maximum number of correctable bits (i.e., 40,000/7,000) which in this case is six (6). Thus, if one of individual storage devices 250 completely fails such that the total size of the encoded codeword divided by N bits are lost, those bits can be recovered through the data decoding process by using the encoded overhead.

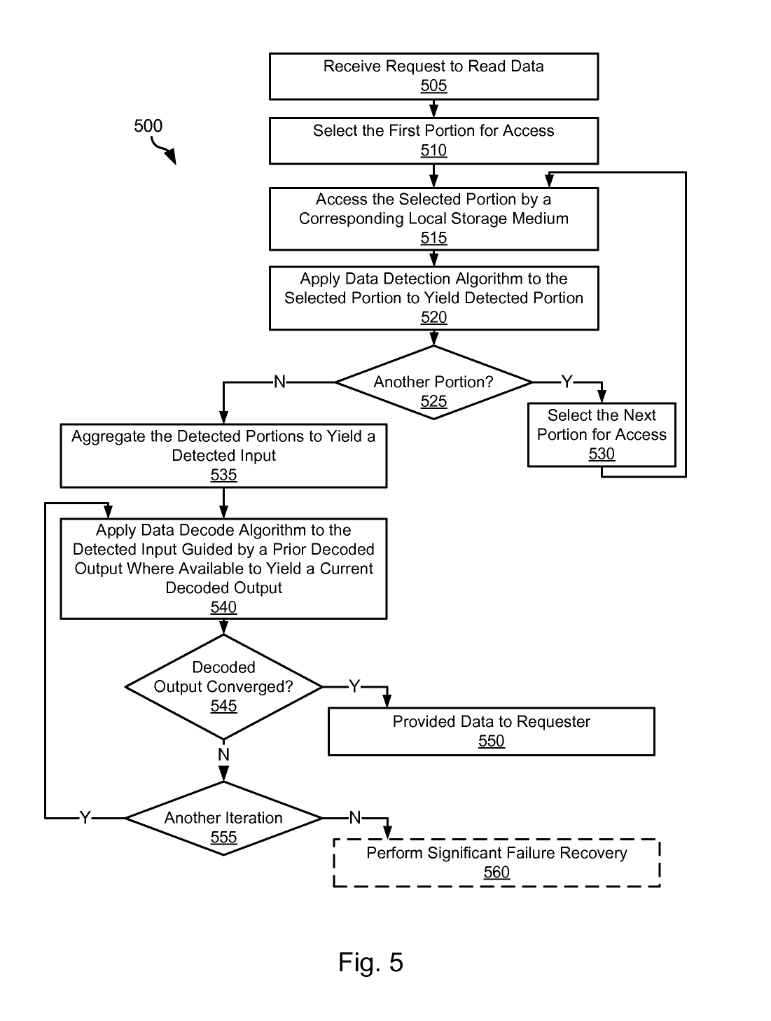

Write data 205 is provided to LDPC encoder circuit 220 that applies a low density parity check encoding algorithm to yield an encoded codeword 225. Turning to FIG. 4, a graphic 400 shows a user data set 405 (corresponding to write data 205) and the resulting LDPC encoded codeword 410 (corresponding to encoded codeword 225). While this embodiment is discussed as using a low density parity data encoding algorithm, based upon the disclosure provided herein, one of ordinary skill in the art will recognize other encoding algorithms that may be used in relation to different embodiments of the present invention. Of note, LDPC codeword 410 is larger than user data 405 as it includes the overhead encoding data (e.g., parity data). In some embodiments, the amount of overhead encoding data is equal to that which would be used if the encoded codeword was to be stored to a single storage device and decoded local to the storage device (e.g., ten (10) to twelve (12) percent overhead). In such a case, the encoding that would have been added at the level of the multi-disk distribution and processing controller (e.g., fifteen (15) to thirty (30) percent overhead) would be saved while providing a reasonable ability to recover data. In another embodiment, the amount of overhead encoding data is greater than that which would be used if the encoded codeword was to be stored to a single storage device and decoded local to the storage device (e.g., twenty (20) to twenty-five (25) percent overhead), but less than the overhead added by the combination of what would have been used at the local storage device level (e.g., ten (10) to twelve (12) percent overhead) and at the level of the multi-disk distribution and processing controller (e.g., fifteen (15) to thirty (30) percent overhead). In such a case, the additional overhead when compared with what would have been used at the local storage device level allows for rapid convergence of the data decoding algorithm in a standard processing situation where bit level errors are occurring and to correct more significant errors that occur when, for example, one of the storage devices fails altogether. Thus, such a scenario allows for greater performance when just bit level errors are occurring and for reasonable performance in the event of catastrophic errors using less overhead than would have existed in, for example, a traditional RAID array where overhead is applied at both the SAN layer and the storage device layer. In yet other embodiments, the amount of overhead encoding data is equal to the overhead added by the combination of what would have been used at the local storage device level (e.g., ten (10) to twelve (12) percent overhead) and at the level of the multi-disk distribution and processing controller (e.g., fifteen (15) to thirty (30) percent overhead). In such a case, the additional overhead when compared with what would have been used at the local storage device level allows for rapid convergence of the data decoding algorithm in a standard processing situation where bit level errors are occurring and greater performance to correct more catastrophic failures that occur when, for example, one of the storage devices fails altogether.

Returning again to FIG. 2, encoded codeword 225 is provided to codeword segmenting circuit 230. Codeword segmenting circuit 230 divides encoded codeword into N portions that are respectively provided to data storage circuit 240 via portion outputs 235. In turn, data storage circuit 240 communicates write commands via bus system 245 to individual storage devices 250. Such write commands request that the N portions are each stored to a respective one of individual storage devices 250. Turning to FIG. 4, graphic 400 shows LDPC encoded codeword 410 divided into N (in this case 4) portions 415, 420, 425, 430; and the N portions being stored to a respective storage medium (i.e., codeword portion 415 stored to storage medium 435, codeword portion 420 stored to storage medium 440, codeword portion 425 stored to storage medium 445, codeword portion 430 stored to storage medium 450).

Where data is to be read, a request to read data is received by from a requesting device (not shown) at storage system 200 along with a read address as part of a read request. The received request is parsed by multi-disk distribution and processing controller 295. Data storage circuit 240 requests the respective portions corresponding to the received read request from the corresponding individual storage devices. The respective individual storage device 250 from which the selected encoded codeword portion is requested applies a data detection algorithm by local data detection circuit 251 to the selected portion to yield a detected portion which is provided back to data storage circuit 240 via bus system 245. Ultimately, data storage circuit 240 receives all of the detected portions corresponding to the received request. The detected potions include hard decision data and correspond to the example encoded codeword portions 415, 420, 425, 430 of FIG. 4. These detected portions are provided by data storage circuit 240 to a codeword assembly and erasure circuit 260. In turn, codeword assembly and erasure circuit 260 aggregates the detected portions to yield a unified detected input. This unified detected output corresponds to an LDPC encoded codeword 410 of FIG. 4.

Codeword assembly and erasure circuit 260 provides the unified detected output to LDPC decoder circuit 270 as a decoder input 264. LDPC decoder circuit 270 applies a low density parity check decoding algorithm to decoder input 264 to yield a decoded output 273. Where decoded output 273 converges (i.e., all errors are corrected), hard decision data corresponding to decoded output 273 is provided as read data 207 to a requesting device (not shown).

Alternatively, where decoded output 273 failed to converge (i.e., errors remain), LDPC decoder circuit 270 re-applies the low density parity check algorithm guided by decoded output 273 to yield an updated decoded output 273. This process continues until either decoded output 273 converges or a maximum number of iterations through LDPC decoder circuit 270 have been exhausted. Where decoded output 273 fails to converge and the maximum number of iterations through LDPC decoder circuit 270 have been exhausted, a significant error condition is indicated.

When a significant error condition is indicated, data storage circuit 240 requests pre-correction data 255 from each of individual storage devices 255 that corresponds to the portions of the requested data. The respective individual storage device 250 from which the selected pre-correction portion is requested provides pre-correction data back to data storage circuit 240 via bus system 245. As an example, storage interface circuit 253 of individual storage device 250 may include an analog front end circuit, an analog to digital converter circuit, and an equalizer circuit. The analog front end circuit applies analog processing to an analog signal sensed from the corresponding storage medium 254 to yield an analog input. The analog to digital converter circuit converts the analog input into a series of digital samples, and the equalizer applies an equalization algorithm to the digital samples to yield an equalized input. In the scenario previously described where detected data from local data detection circuit 251 is provided, the data detection algorithm is applied to the equalized input to yield the detected portion. The pre-correction data provided by storage interface circuit 253 may be either the digital samples (i.e., an x-output) or the equalized output (i.e., a y-output) depending upon the implementation of the respective individual storage devices. Where the pre-correction data is the aforementioned digital samples, then multi-disk distribution and processing controller 295 additionally applies an equalization algorithm using an equalizer circuit (not shown) on the digital samples to yield an equalized output.

These pre-correction portions are provided by data storage circuit 240 to codeword assembly and erasure circuit 260. In turn, codeword assembly and erasure circuit 260 aggregates the pre-correction portions to yield a unified pre-correction input. This unified pre-correction input corresponds to LDPC encoded codeword 410 of FIG. 4. Codeword assembly and erasure circuit 260 provides the unified pre-correction input to data detector circuit 280 as a detector input 262 (where the data was not already equalized by storage interface circuit 253, the equalization is performed by an equalizer circuit included as part of codeword assembly and erasure circuit 260). Data detector circuit 280 applies a data detection algorithm to detector input 262 to yield a detected output 282 which is provided to codeword assembly and erasure circuit 260.

Codeword assembly and erasure circuit 260 is provided an indication of whether a failure of one or more of individual storage devices 250 occurred. Where a failure of one or more of individual storage devices 250 is indicated, codeword assembly and erasure circuit 260 applies erasure to the soft data received as detector output 282. Such erasure includes lowering the soft data to a value (e.g., 0) which indicates a low confidence that the data for that particular region was properly detected. By lowering the confidence, there is a higher likelihood that values corresponding to the failed individual storage device will be modified when compared with values from non-failing individual storage devices during subsequent application of a data decode algorithm.

Codeword assembly and erasure circuit 260 then provides detector output 282 (either unmodified or modified by the aforementioned erasure process) to LDPC decoder circuit 270 as decoder input 264. LDPC decoder circuit 270 applies a low density parity check decoding algorithm to decoder input 264 to yield a decoded output 273. Where decoded output 273 converges (i.e., all errors are corrected), hard decision data corresponding to decoded output 273 is provided as read data 207 to a requesting device (not shown).

Alternatively, where decoded output 273 failed to converge (i.e., errors remain), LDPC decoder circuit 270 re-applies the low density parity check algorithm guided by decoded output 273 to yield an updated decoded output 273. This process continues until either decoded output 273 converges or a maximum number of iterations through LDPC decoder circuit 270 have been exhausted. Where decoded output 273 fails to converge and the maximum number of iterations through LDPC decoder circuit 270 have been exhausted, it is determined if more global iterations (an iteration through data detector circuit coupled with one or more local iterations through data decoder circuit 270) is allowed. Where another global iteration is allowed, a decoded output 272 corresponding to decoded output 273 is provided to data detector circuit 280. In turn, data detector circuit re-applies the data detection algorithm guided by decoded output to yield an updated detector output 282 which is provided without erasure back to LDPC decoder circuit 270 where it is re-decoded. This process continues until either decoded output 273 converges or a maximum number of global and local iterations has been performed.

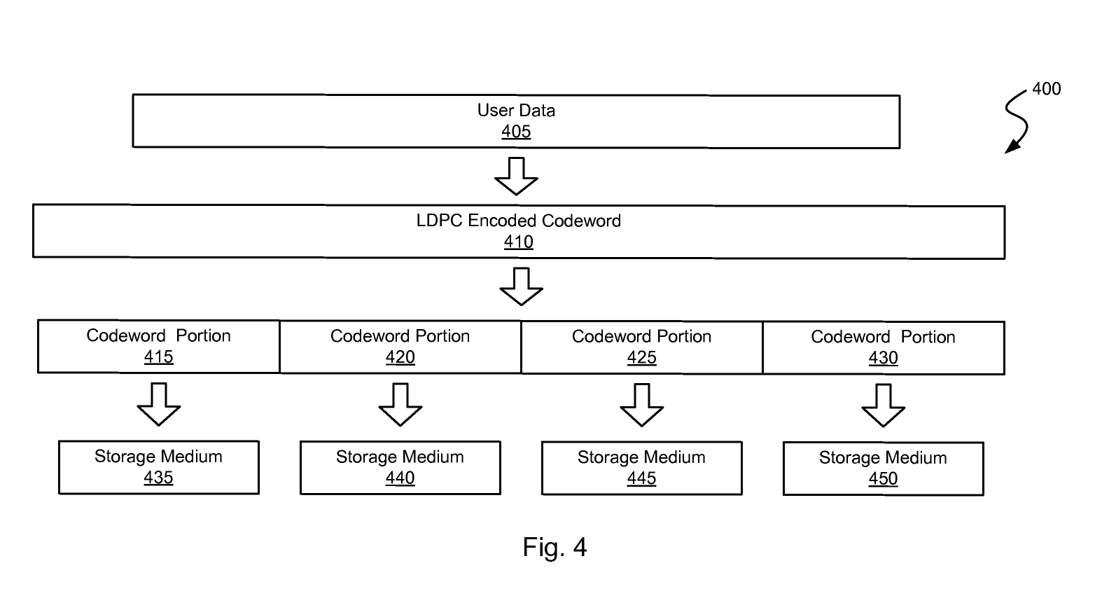

Turning to FIG. 3, a flow diagram 300 shows a method in accordance with some embodiments of the present invention for encoding and storing data across multiple storage media. Following flow diagram 300, a user data set is received from a requesting device at a storage system along with a storage address as part of a write request (block 305). Turning to FIG. 4, a graphic 400 shows a user data set 405 corresponding to the received user data set is graphically represented. In some cases, the requesting device is a server and the receiving device is a multi-disk distribution and processing controller implemented as part of a storage system accessible to the server. Returning to FIG. 3, it is determined how many individual storage devices (N) are in included in the storage system (block 310). A data encoding algorithm is applied to the received user data set to yield an encoded codeword (block 315). In some cases, the data encoding algorithm is a low density parity data encoding algorithm. Based upon the disclosure provided herein, one of ordinary skill in the art will recognize other encoding algorithms that may be used in relation to different embodiments of the present invention.

Turning to FIG. 4, graphic 400 shows an LDPC codeword 410 generated by applying a low density parity check encoding algorithm to user data 405 is shown. Of note, LDPC codeword 410 is larger than user data 405 as it includes the overhead encoding data (e.g., parity data). In some embodiments, the amount of overhead encoding data is equal to that which would be used if the encoded codeword was to be stored to a single storage device and decoded local to the storage device (e.g., ten (10) to twelve (12) percent overhead). In such a case, the encoding that would have been added at the level of the multi-disk distribution and processing controller (e.g., fifteen (15) to thirty (30) percent overhead) would be saved while providing a reasonable ability to recover data. In another embodiment, the amount of overhead encoding data is greater than that which would be used if the encoded codeword was to be stored to a single storage device and decoded local to the storage device (e.g., twenty (20) to twenty-five (25) percent overhead), but less than the overhead added by the combination of what would have been used at the local storage device level (e.g., ten (10) to twelve (12) percent overhead) and at the level of the multi-disk distribution and processing controller (e.g., fifteen (15) to thirty (30) percent overhead). In such a case, the additional overhead when compared with what would have been used at the local storage device level allows for rapid convergence of the data decoding algorithm in a standard processing situation where bit level errors are occurring and to correct more significant errors that occur when, for example, one of the storage devices fails altogether. Thus, such a scenario allows for greater performance when just bit level errors are occurring and for reasonable performance in the event of catastrophic errors using less overhead than would have existed in, for example, a traditional RAID array where overhead is applied at both the SAN layer and the storage device layer. In yet other embodiments, the amount of overhead encoding data is equal to the overhead added by the combination of what would have been used at the local storage device level (e.g., ten (10) to twelve (12) percent overhead) and at the level of the multi-disk distribution and processing controller (e.g., fifteen (15) to thirty (30) percent overhead). In such a case, the additional overhead when compared with what would have been used at the local storage device level allows for rapid convergence of the data decoding algorithm in a standard processing situation where bit level errors are occurring and greater performance to correct more catastrophic failures that occur when, for example, one of the storage devices fails altogether.

Returning again to FIG. 3, the encoded codeword is divided into N portions or segments where N is the previously determined number of individual storage devices (block 320). The N portions are then stored to corresponding media of the N storage media (block 325). Local write circuit 252 of individual storage device 250 is operable to format the portion of the encoded codeword received from data storage circuit 240 via bus system 245, and to store the formatted data to storage medium 254 via a storage interface circuit 253. The combination of local write circuit 252 and storage interface circuit 253 may be implemented using any circuitry known in the art for receiving data and storing a representation of that data to a storage medium. Turning to FIG. 4, graphic 400 shows LDPC encoded codeword 410 divided into N (in this case 4) portions 415, 420, 425, 430; and the N portions being stored to a respective storage medium (i.e., codeword portion 415 stored to storage medium 435, codeword portion 420 stored to storage medium 440, codeword portion 425 stored to storage medium 445, codeword portion 430 stored to storage medium 450).

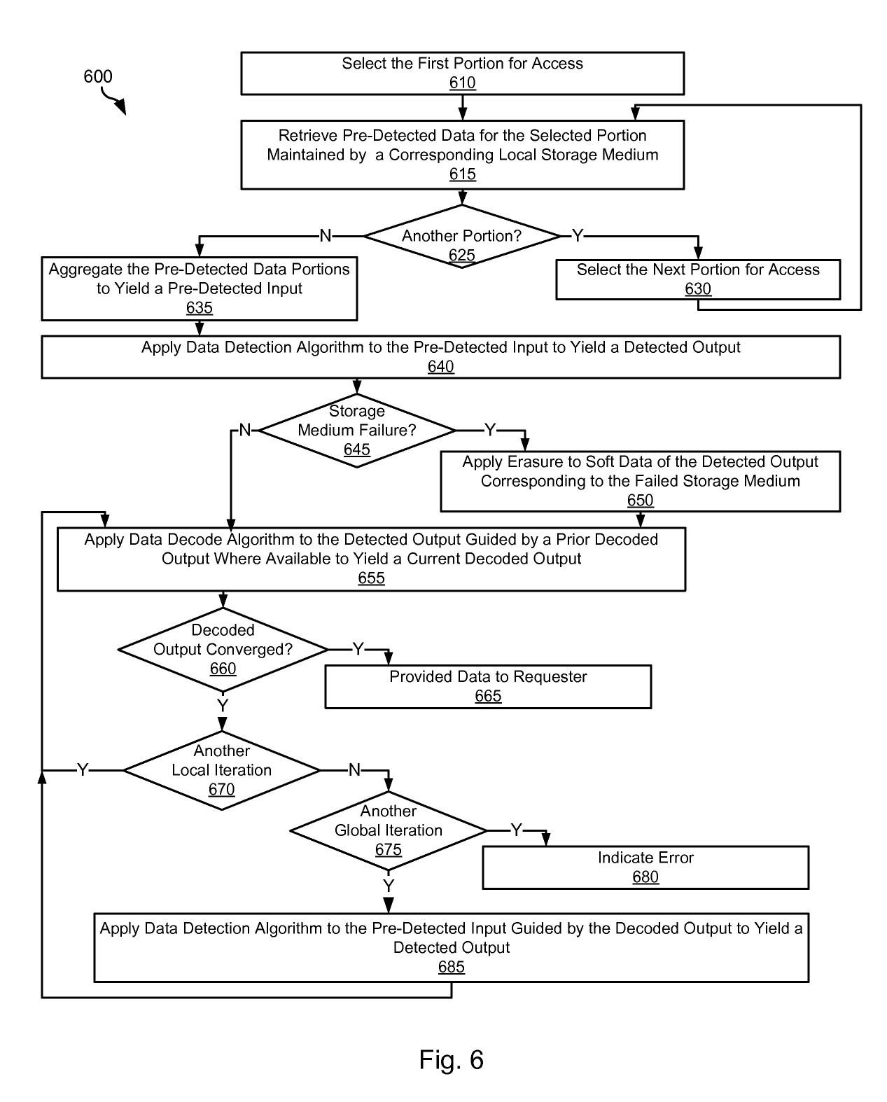

Turning to FIG. 5, a flow diagram 500 shows a method in accordance with some embodiments for recovering data stored across multiple storage media in a standard read scenario. Following flow diagram 500, a request to read data is received by from a requesting device at a storage system along with a read address as part of a read request (block 505). The received request is parsed by a multi-disk distribution and processing controller. The multi-disk distribution and processing controller selects a first portion of the requested data set (block 510), and the selected portion is accessed from the corresponding individual storage device or local storage medium (block 515). Turning to FIG. 4 as an example, multi-disk distribution and processing controller selects encoded codeword portion 415 and issues a read request to storage medium 435 to access encoded codeword portion 415. The local storage medium from which the selected encoded codeword portion is requested applies a data detection algorithm to the selected portion to yield a detected portion (block 520). This detected portion is then returned by the local storage medium to the multi-disk distribution and processing controller. It is then determined whether more portions of the requested data set remain to be accessed (block 525). Where another portion remains to be accessed (block 525), the next portion is selected for access (block 530) and the processes of blocks 515-525 are repeated until all portions of the requested data are accessed and provided back to multi-disk distribution and processing controller as respective detected portions. The detected potions include hard decision data.

Alternatively, where no additional portions remain to be accessed (Block 525), the multi-disk distribution and processing controller aggregates the detected portions received from the individual storage devices to yield a detected input (block 535). A data decode algorithm is then applied to the detected input to yield a current decoded output (block 540). For the second and later iterations applying the data decode algorithm, application of the data decode algorithm is guided by a decoded output from a prior iteration. It is determined whether application of the data decode algorithm converged (i.e., resulted in correction of all remaining errors) (block 545). Where the decoded output converged (block 545), the resulting error free data is provided by the multi-disk distribution and processing controller to the requesting device (block 550).

Otherwise, where the decoded output failed to converge (block 545), it is determined whether another iteration of the data decode algorithm is to be performed (block 555). In some cases, up to ten iterations are allowed. Based upon the disclosure provided herein, one of ordinary skill in the art will recognize different numbers of allowable iterations of the data decode algorithm that may be used in relation to different embodiments of the present invention. Where another iteration applying the data decode algorithm is allowed (block 555), the processes of blocks 540-555 are repeated for the next iteration. Alternatively, where another iteration applying the data decode algorithm is not allowed (block 555), a significant failure recovery process is performed (block 560).

One implementation of the significant failure recovery process is shown as a flow diagram 600 of FIG. 6. Turning to FIG. 6 and following flow diagram 600, a first portion of the requested data is again selected (block 610). The multi-disk distribution and processing controller requests pre-correction data corresponding to the portion from the corresponding individual storage device, and in turn the individual storage device retrieves the requested pre-correction data and provides it to the multi-disk distribution and processing controller (block 615). As an example, the individual storage device may include a storage interface circuit having an analog front end circuit, an analog to digital converter circuit, and an equalizer circuit. The analog front end circuit applies analog processing to an analog signal sensed from the corresponding storage medium 254 to yield an analog input. The analog to digital converter circuit converts the analog input into a series of digital samples, and the equalizer applies an equalization algorithm to the digital samples to yield an equalized input. In the scenario previously described in relation to FIG. 5, the data detection algorithm is applied to the equalized input to yield the detected output. The pre-correction data provided by local disk controllers may be either the digital samples (i.e., an x-output) or the equalized output (i.e., a y-output) depending upon the implementation of the respective individual storage devices. Where the pre-correction data is the aforementioned digital samples, then multi-disk distribution and processing controller additionally applies an equalization algorithm on the digital samples to yield an equalized output.

It is then determined whether more portions of the requested data set remain to be retrieved (block 625). Where another portion remains to be retrieved (block 625), the next portion is selected for access (block 630) and the processes of blocks 615-625 are repeated until all portions of the requested data are accessed and provided back to multi-disk distribution and processing controller as respective pre-correction portions. The pre-correction potions include a multi-bit value for each bit.

Alternatively, where no additional portions remain to be accessed (Block 625), the multi-disk distribution and processing controller aggregates the pre-correction portions received from the individual storage devices to yield a pre-correction input (block 635). A data detection algorithm is then applied by the multi-disk distribution and processing controller to the pre-correction input (or a re-equalized instance of the pre-correction input) to yield a detected output (block 640). It is then determined whether the significant errors detected as part of the process of FIG. 5 resulted from a catastrophic failure of one of the multiple individual storage devices (block 645). Where an individual storage device is determined to have failed (block 645), erasure is applied to the soft data of detected output corresponding to the failed individual storage device (block 650). Such erasure includes lowering the soft data to a value (e.g., 0) which indicates a low confidence that the data for that particular region was properly detected. By lowering the confidence, there is a higher likelihood that values corresponding to the failed individual storage device will be modified when compared with values from non-failing individual storage devices during subsequent application of a data decode algorithm.

In either case, a data decode algorithm is then applied to the detected input to yield a current decoded output (block 655). For the second and later iterations applying the data decode algorithm, application of the data decode algorithm is guided by a decoded output from a prior iteration. It is determined whether application of the data decode algorithm converged (i.e., resulted in correction of all remaining errors) (block 660). Where the decoded output converged (block 660), the resulting error free data is provided by the multi-disk distribution and processing controller to the requesting device (block 665).

Otherwise, where the decoded output failed to converge (block 660), it is determined whether another local iteration of the data decode algorithm is to be performed (block 670). As used herein, the phrase “local iteration” indicates application of only the data decode algorithm. In contrast, the phrase “global iteration” indicates a combination of application of the data detection algorithm and one or more iterations of the data decode algorithm. In some cases, up to ten local iterations are allowed. Based upon the disclosure provided herein, one of ordinary skill in the art will recognize different numbers of allowable local iterations of the data decode algorithm that may be used in relation to different embodiments of the present invention. Where another iteration applying the data decode algorithm is allowed (block 670), the processes of blocks 655-670 are repeated for the next iteration.

Alternatively, where another local iteration applying the data decode algorithm is not allowed (block 670), it is determined whether another global iteration is allowed (block 675). Where another global iteration is allowed (block 675), the data detection algorithm is re-applied guided by the current decoded output (block 685) and the processes of blocks 655-680 are repeated for the next global iteration. In some cases, up to seven global iterations are allowed. Based upon the disclosure provided herein, one of ordinary skill in the art will recognize different numbers of allowable global iterations that may be used in relation to different embodiments of the present invention. Otherwise, where another global iteration is allowed (block 675), an error is indicated (block 680).

It should be noted that the various blocks discussed in the above application may be implemented in integrated circuits along with other functionality. Such integrated circuits may include all of the functions of a given block, system or circuit, or only a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent, albeit such a system would thus be software and not hardware. In other cases, the one part of a given system, block or circuit may be implemented in software or firmware, while other parts are implemented in hardware.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A storage system, the storage system comprising:
a first storage device including a first storage medium and a first data detector circuit, wherein the first data detector circuit is operable to apply a data detection algorithm to a first pre-correction data set derived from the first storage medium to yield a first detected output;
a second storage device including a second storage medium and a second data detector circuit, wherein the second data detector circuit is operable to apply the data detection algorithm to a second pre-correction data set derived from the second storage medium to yield a second detected output; and
a storage system controller including a data decoder circuit and a codeword assembly circuit, wherein the storage system controller is operable to:
receive the first detected output and the second detected output;
assemble the first detected output and the second detected output by the codeword assembly circuit to yield a unified detected output; and
apply a data decode algorithm to the unified detected output by the data decoder circuit to yield a decoded output.

2. The storage system of claim 1, wherein the storage system controller is implemented as part of a first integrated circuit, wherein the first data detector circuit is implemented as part of a second integrated circuit, and wherein the second data detector circuit is implemented as part of a third integrated circuit.

3. The storage system of claim 1, wherein the first detected output includes only hard decision data.

4. The storage system of claim 1, wherein the first detected output includes soft decision data.

5. The storage system of claim 1, wherein the first storage device further comprises a first write circuit and the second storage device further comprises a second write circuit, and wherein the storage system controller further comprises:
a data encoder circuit operable to encode a user data input to yield an encoded codeword;
a codeword segmenting circuit operable to divide the encoded codeword into multiple portions including at least a first portion and a second portion; and
a data storage circuit operable to direct the first portion to the first write circuit and the second portion to the second write circuit, wherein the first portion corresponds to the first pre-correction data set and the second portion corresponds to the second pre-correction data set.

6. The storage system of claim 1, wherein the first storage device is a first hard disk drive and the second storage device is a second storage device.

7. The storage system of claim 1, wherein the decoded output is a first decoded output, wherein the storage system controller further comprises a third data detector circuit, wherein the storage system controller is further operable to:
receive a first pre-detected data set corresponding to the first pre-correction data set and a second pre-detected data set corresponding to the second pre-correction data set;
assemble the first pre-detected data set and the second pre-detected data set by the codeword assembly circuit to yield a unified pre-detected output;
apply a data detection algorithm to the unified pre-detected output by the third data detector circuit to yield a third detected output; and
apply the data decode algorithm to the third detected output by the data decoder circuit to yield a second decoded output.

8. The storage system of claim 7, wherein the first pre-detected data set includes more bits than the first detected output.

9. The storage system of claim 7, wherein the third detected output includes soft decision data, and wherein the first detected output and the second detected output each include only hard decision data.

10. The storage system of claim 7, wherein the codeword assembly circuit is further operable to modify the third detected output to erase elements of the third detected output corresponding to the first pre-correction data set when the first storage device is identified as failed.

11. The storage system of claim 1, wherein access to the storage system is controlled by a requesting device communicably coupled to the storage system controller.

12. The storage system of claim 1, wherein the data decoder circuit is a low density parity check decoder circuit.

13. A storage system, the system comprising:
a first storage device including a first storage medium and a first analog to digital converter circuit, wherein the first analog to digital converter circuit is operable to convert a first analog signal derived from the first storage medium to yield a first series of samples;
a second storage device including a second storage medium and a second analog to digital converter circuit, wherein the second analog to digital converter circuit is operable to convert a second analog signal derived from the second storage medium to yield a second series of samples; and
a storage system controller including a data decoder circuit, a data detector circuit, and a codeword assembly circuit, wherein the storage system controller is operable to:
receive a first pre-correction data set derived from the first series of samples and a second pre-correction data set derived from the second series of samples;
assemble the first pre-correction data set and the second pre-correction data set by the codeword assembly circuit to yield a unified pre-correction output;
apply a data detection algorithm to a detector input derived from the unified pre-correction output by the third data detector circuit to yield a third detected output; and
apply the data decode algorithm to the third detected output by the data decoder circuit to yield a second decoded output.

14. The storage system of claim 13, wherein the storage system controller is implemented as part of a first integrated circuit, wherein the first analog to digital converter circuit is implemented as part of a second integrated circuit, and wherein the second analog to digital converter circuit is implemented as part of a third integrated circuit.

15. The storage system of claim 13, wherein the first storage device further comprises a first equalizer circuit operable to equalize the first series of samples to yield a first equalized output, wherein the second storage device further comprises a second equalizer circuit operable to equalize the second series of samples to yield a second equalized output, wherein the first pre-correction output is the first equalized output and the second pre-correction output is the second equalized output, and wherein the detector input is the unified pre-correction output.

16. The storage system of claim 13, wherein the first pre-correction data set is the first series of samples and the second pre-correction data set is the second series of samples, wherein the storage system controller further includes an equalizer circuit, and wherein the equalizer circuit is operable to equalize the unified pre-correction output to yield the detector input.

17. The storage system of claim 13, wherein the codeword assembly circuit is further operable to modify the detected output to erase elements of the detected output corresponding to the first pre-correction data set when the first storage device is identified as failed.

18. The storage system of claim 13, wherein access to the storage system is controlled by a requesting device communicably coupled to the storage system controller.

19. A method for data storage, the method comprising:
providing a first storage device including a first storage medium and a first data detector circuit; wherein the first data detector circuit is operable to apply a data detection algorithm to a first pre-correction data set derived from the first storage medium to yield a first detected output;
providing a second storage device including a second storage medium and a second data detector circuit, wherein the second data detector circuit is operable to apply the data detection algorithm to a second pre-correction data set derived from the second storage medium to yield a first detected output;
using a storage system controller to:
encode a user data input to yield an encoded data set;
segment the user data input to yield multiple portions including at least a first portion and a second portion;
direct the first portion to the first storage device to be stored on the first storage medium, wherein the first portion corresponds to the first pre-correction data set; and
direct the second portion to the second storage device to be stored on the second storage medium, wherein the second portion corresponds to the second pre-correction data set.

20. The method of claim 19, the method further comprising:
using the storage system controller to:
receive a read request;
request the first detected data set from the first storage device;
request the second detected data set from the second storage device;
receive the first detected output and the second detected output;
aggregate the first detected data set and the second detected data set to yield a unified detected output; and
apply the data decode algorithm to the unified detected output to yield a decoded output.

21. The method of claim 19, the method further comprising:
using the storage system controller to:
receive a read request;
request the first pre-correction data set from the first storage device;
request the second pre-correction data set from the second storage device;
receive the first pre-correction output and the second pre-correction output;
aggregate the first pre-correction data set and the second pre-correction data set to yield a unified pre-correction output;
apply a data detection algorithm to a detector input derived from the unified pre-correction output by a third data detector circuit to yield a third detected output; and
apply the data decode algorithm to the third detected output by the data decoder circuit to yield a second decoded output.

22. The method of claim 21, wherein the first pre-correction output is a first equalized output generated by a first equalizer included as part of the first storage device, and wherein the second pre-correction output is a second equalized output generated by a second equalizer included as part of the second storage device.

23. The method of claim 21, wherein the method further comprises:
erasing a portion of the third detected output corresponding to the first pre-correction output based upon a failure of the first storage device.
